(19) United States
(12) Patent Application Publication
(10) Pub. No.: US 2021/0301918 A1
(43) Pub. Date: Sep. 30, 2021

(54) SHIFT APPARATUS

(71) Applicant: HONDA MOTOR CO., LTD., Tokyo (JP)

(72) Inventors: Fumitaka ABE, Saitama (JP); Satoshi KONO, Saitama (JP)

(21) Appl. No.: 17/210,479

(22) Filed: Mar. 23, 2021

(30) Foreign Application Priority Data
Mar. 30, 2020 (JP) 2020-061198

(51) Int. Cl. F16H 59/08; F16H 59/02

(52) U.S. Cl. CPC F16H 59/08; F16H 2059/0221; F16H 2059/082; F16H 59/0204

(57) ABSTRACT

To provide such a shift apparatus that, even if, at the time of electrically applying a reaction force to a rotation operation of a shift apparatus, an abnormality occurs in a control device that provides an instruction to apply this reaction force, it is not enabled to switch to a range the operation of which is originally restricted. In a case where an abnormality occurs in reaction force application instruction means, reaction force application control means applies a reaction force against a rotation operation in a direction opposite to a parking range relative to a current range. Thereby, it is possible to reduce the possibility that a vehicle travels with an instruction to apply reaction force remaining in an abnormal state.

This application is based on and claims the benefit of priority from Japanese Patent Application No. 2020-061198, filed on 30 Mar. 2020, the content of which is incorporated herein by reference.

### BACKGROUND OF THE INVENTION

### Field of the Invention

The present invention relates to a shift apparatus for switching a range of a transmission mounted on a vehicle and, in particular, to a shift apparatus capable of applying a reaction force for restricting an operation of a driver.

### Related Art

A shift apparatus that is provided near a display panel in front of a driver or a vehicle travel operation handle in a vehicle and is capable of switching to and selecting a range by a rotation operation of a rotation operation member has been conventionally known. In the conventional shift apparatus, a current shift range is indicated according to a range selected by the rotation operation member.

In Japanese Unexamined Patent Application, Publication No. 2013-47074, a shift apparatus is described in which selection among shift ranges that a driver can switch to by one operation is restricted so that shift range switching that is not intended by the driver can be avoided from being performed. As described above, devices are made so that shift range switching intended by a driver can be performed.
Patent Document 1: Japanese Unexamined Patent Application, Publication No. 2013-47074

It is considered to, in a rotation operation type shift apparatus, electrically provide a reaction force to a rotation operation of the shift apparatus in order to prevent a range other than a predetermined range intended by a driver from being entered. As for this electrical reaction force, by applying the reaction force after the driver performs an operation continuously to some extent, the driver can recognize that the operation is restricted. Further, unnecessary power consumption is suppressed.

### SUMMARY OF THE INVENTION

When an abnormality occurs in a control device that provides an instruction to apply this reaction force, however, the reaction force cannot be provided to an appropriate position, and a problem occurs that it is enabled to switch to a range the operation of which is originally restricted.

The present invention has been devised to solve such a problem included in the conventional technique, and an object is to provide a rotation operation type shift apparatus in which, even if, when a reaction force is electrically provided to a rotation operation of the shift apparatus in order to prevent a range other than a predetermined range intended by a driver from being entered, an abnormality occurs in a control device that provides an instruction to apply this reaction force, it is not enabled to switch to a range the operation of which is originally restricted.

In order to solve such a problem, in the present invention, there is provided a shift apparatus of a vehicle, including a shift member that is enabled to switch among ranges arranged in order of a parking range (P), a reverse range (R), a neutral range (N) and a forward travel range (D) by rotationally operating a dial-type operation member, the shift apparatus further including: reaction force application control means configured to apply a reaction force when the shift member is rotationally operated; and reaction force application instruction means configured to specify a position to which the reaction force is to be applied, to the reaction force application control means; in which, in a case where an abnormality occurs in the reaction force application instruction means, the reaction force application control means applies a reaction force against the rotation operation in a direction opposite to the parking range relative to a current range.

By, in the case where an abnormality occurs in the reaction force application instruction means, applying a reaction force against a rotation operation in the direction opposite to the parking range relative to a current range, that is, providing a reaction force wall for the current range on an opposite side of a parking range side, it is possible to make it difficult to change from the current range to the forward travel range side. Thereby, it is possible to reduce the possibility that a vehicle travels with an instruction to apply a reaction force remaining in an abnormal state.

Further, in this case, in the present invention, when a rotation operation from the current range to the parking range side is performed in the case where the abnormality occurs in the reaction force application instruction means, the reaction force application control means applies a reaction force against the rotation operation in the direction opposite to the parking range relative to a range switched to by the rotation operation.

By narrowing down a rotation operation range by a driver's rotation operation in the case of an abnormality in the reaction force application instruction means, it is possible to further prevent unintentional change to the forward travel range.

Further, in this case, in the present invention, in the case where the abnormality occurs in the reaction force application instruction means during automatic parking range control of automatically switching the vehicle to the parking range (P) after a power source (IG) of the vehicle is turned off, the vehicle maintains the parking range irrespective of the rotation operation.

Even if, in the case where the reaction force application instruction means becomes abnormal during the automatic parking range control, the driver performs a rotation operation by the shift member during the automatic parking range control, it is possible to, by maintaining the parking range without switching to a range that the driver intended to switch to by the rotation operation, prevent the vehicle from moving with the reaction force application instruction means remaining abnormal.

Further, in this case, in the present invention, the shift apparatus further includes: display means configured to, when any of the ranges is switched to, cause the range to be indicated; and indication instruction means configured to instruct the display means to perform indication; and, in a case where an abnormality occurs in the indication instruction means during the automatic parking range control, the abnormality is notified (extinction, blinking, all lights on, and the like) by the display means, and the vehicle maintains the parking range irrespective of the rotation operation.

Even if the indication instruction means becomes abnormal during the automatic parking range control, it is possible for the driver to recognize that the indication instruction means is abnormal, by activating the notification means. Further, even if the driver performs a rotation operation by the shift member during the automatic parking range control, it is possible to, by maintaining the parking range without switching to a range that the driver intended to switch to by the rotation operation, prevent the vehicle from moving with the indication instruction means remaining abnormal.

Thus, the present invention relates to a rotation operation type shift apparatus, and, even if, at the time of electrically applying a reaction force to a rotation operation of the shift apparatus in order to prevent switching to a range other than a predetermined range intended by a driver, an abnormality occurs in the reaction force application instruction means or the indication instruction means, it is possible to prevent switching to a range that is not intended by the driver and prevent the vehicle from moving with the abnormality remaining.

### BRIEF DESCRIPTION OF THE DRAWINGS

FIG. 1 is a diagram showing an overview of a control path system of a shift apparatus of the present invention on a vehicle;

FIG. 2 is a diagram showing arrangement of an operation members and a display member in front of a driver in a vehicle according to the present invention;

FIG. 3 is a block diagram showing the control path system of the shift apparatus of the present invention;

FIG. 4 is an overview configuration diagram of the operation member and the display member of the shift apparatus of the present invention;

FIG. 5 is a schematic diagram showing reaction force walls;

FIG. 6 is a diagram showing movement of a reaction force wall in a case where an abnormality occurs in reaction force application instruction means;

FIG. 7 is a diagram of movement of the reaction force wall in a case where range switching is performed when the reaction force application instruction means is abnormal;

FIG. 8 is a diagram of movement of the reaction force wall when an abnormality occurs in the reaction force application instruction means during automatic parking control; and

FIG. 9 is a diagram of movement of the reaction force wall when an abnormality occurs in indication instruction means during the automatic parking control.

### DETAILED DESCRIPTION OF THE INVENTION

An embodiment of the present invention will be described in detail with reference to drawings.

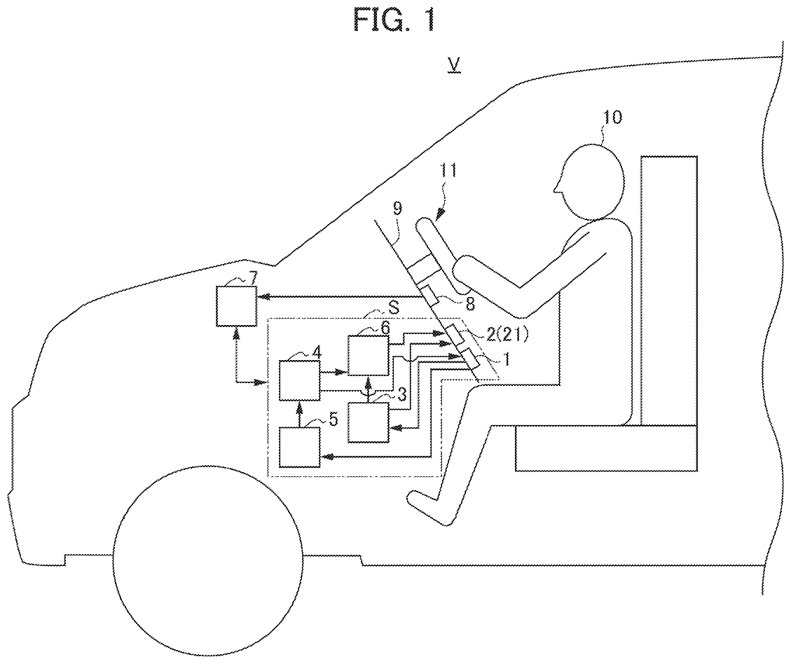

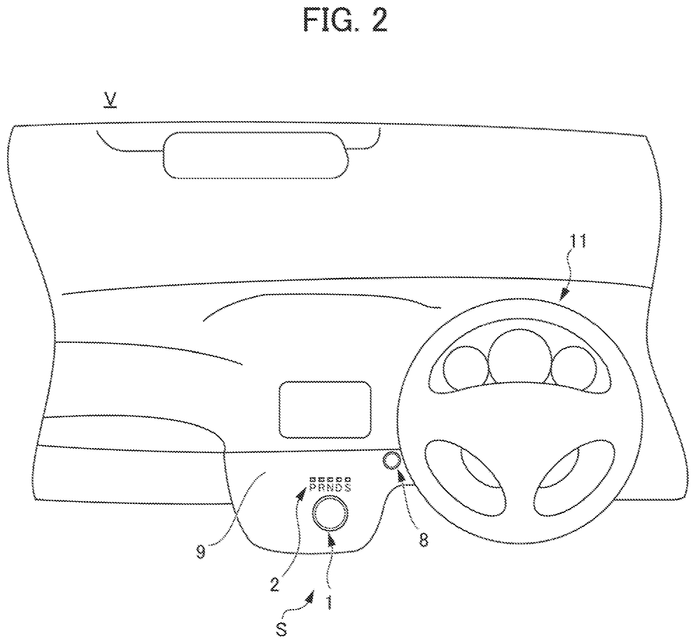

A shift apparatus S of a vehicle V is provided with a shift member 1, display means 2 including notification means 21, indication instruction means 3, reaction force application instruction means 4, reaction force application control means 5 and abnormality detection means 6. The shift member 1 is an operation member for a driver 10 to select a shift range of a transmission of the vehicle V. As shown in FIGS. 1 and 2, the shift member 1 is arranged on a display panel 9 in front of the driver 10 below the left side of a vehicle travel operation handle 11.

The display means 2 including the notification means 21 is arranged above the shift member 1. On the display means 2, indication of a range is instructed by the indication instruction means 3 arranged in the vehicle V. In addition, in the vehicle V, the reaction force application instruction means 4 that applies a reaction force against an operation of the shift member 1 of the shift apparatus S, the reaction force application control means 5 that controls the reaction force application instruction means 4 and the abnormality detection means 6 that detects an abnormality in the indication instruction means 3 and the reaction force application instruction means 4 are provided.

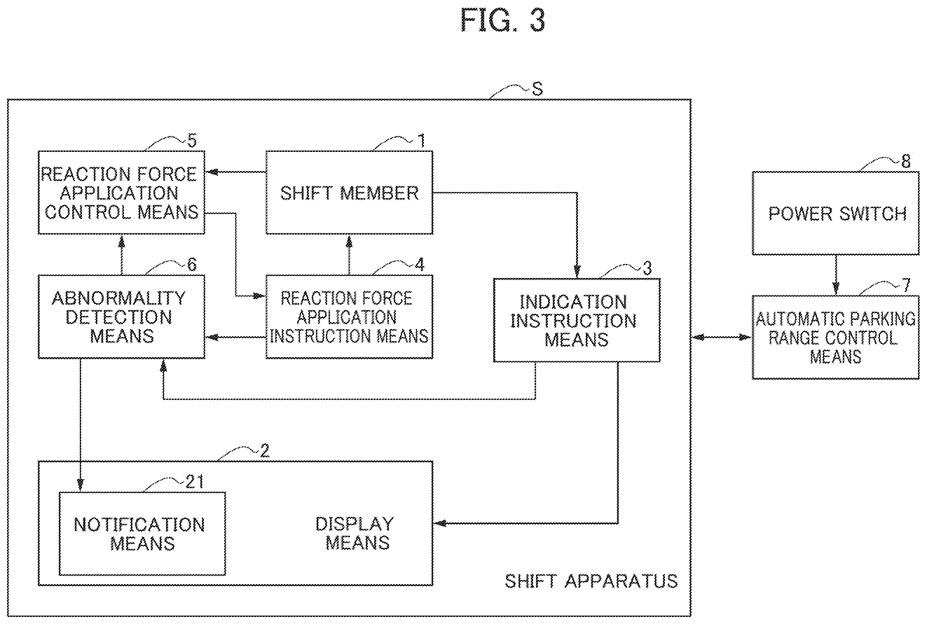

FIG. 3 is a block diagram showing a control path system of the shift apparatus S. The shift member (the operation member) 1 sends information (a signal) about a rotation operation by the driver 10 to the indication instruction means 3 and causes a range to be indicated on the display means 2. Further, the shift member (the operation member) 1 sends the information (the signal) about the rotation operation by the driver 10 to the reaction force application control means 5, a signal from the reaction force application control means 5 is sent to the reaction force application instruction means 4; and information (a signal) about application of a reaction force to the rotation operation is sent from the reaction force application instruction means 4 to the shift member 1 (the operation member). Abnormality information about the indication instruction means 3 and abnormality information about the reaction force application instruction means 4 are collected to the abnormality detection means 6; the abnormality information about the indication instruction means 3 is sent to the notification means 21 of the display means 2; and the pieces of abnormality information about both of the indication instruction means 3 and the reaction force application instruction means 4 are sent to the reaction force application control means 5. Between the shift apparatus S and automatic parking range control means 7, information is mutually exchanged. Further, the automatic parking range control means 7 receives power source information about the vehicle V from a power switch 8.

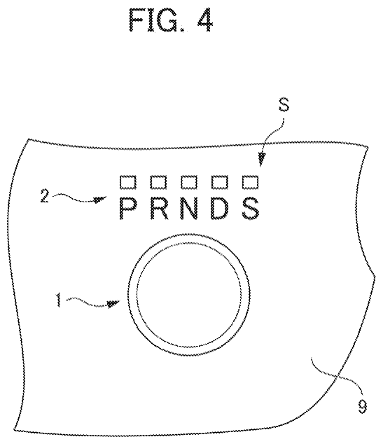

As shown in FIG. 4, the shift member 1 is configured with a rotation operation member having a dial-type cylindrical knob member. The display means 2 is arranged above the shift member 1 and indicates a range selected by operating the shift member 1. An abnormal state or the like can be notified by an indication portion for a range blinking, and, therefore, the display means 2 can be said to include (serve as) the notification means 21. In the present invention, when an abnormality occurs in the indication instruction means 3, the driver 10 is notified of the abnormal state by indication portions for all the ranges on the display means 2 blinking.

Ranges selected by the shift member 1 and indicated on the display means 2 include, in addition to a P (parking) range at the time of parking, an R (reverse) range for causing the vehicle V to reversely travel, an N (neutral) range for blocking transmission of driving force and a D (forward travel) range for causing the vehicle V to travel forward, an L (low (1st speed)) range, a 2 (second) range, an S (sports mode) range, a B (regenerative braking) range and the like. The display means 2 of the embodiment of the present invention has the P, R, N, D and S ranges, and indications indicating the ranges, respectively, are displayed on the display means 2 in order of P, R, N, D and S from the left side.

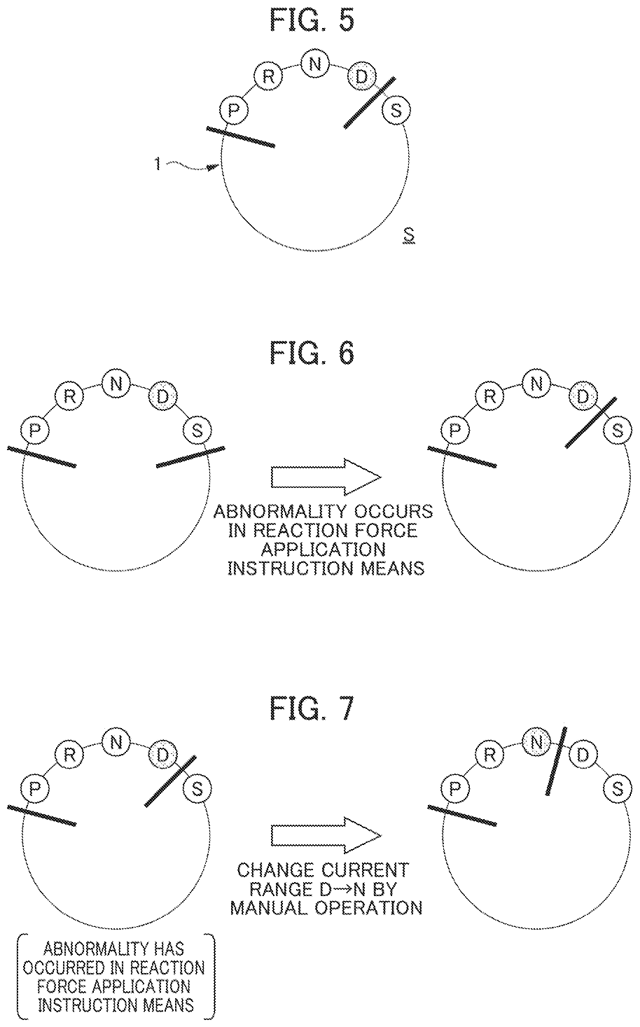

Next, aspects of the present invention will be described with reference to FIGS. 5 to 9. FIG. 5 is a diagram for illustrating a schematic diagram showing a relationships among the ranges and reaction force walls in the shift apparatus S; and FIGS. 6 to 8 are schematic diagrams showing a change (movement) of a reaction force wall relative to a current range of the vehicle V in the shift apparatus S when a change occurs in a state of the shift apparatus S or the like in the vehicle V.

First, the schematic diagram of the shift apparatus S and the reaction force walls will be described using FIG. 5. In FIG. 5, the shift apparatus S having the P, R, N, D and S ranges and the shift member 1 in a circular shape for selecting a range is schematically shown. Among the ranges, the D range is shown being dotted, and this indicates that the vehicle V is currently traveling in the D range. Line segments extending in a radial direction from the center of a circle indicating the shift member 1 are drawn outside the P range, and between the D range and the S range, respectively. The line segments indicate the reaction force walls. To describe the line segment (the reaction force wall) between the D range and the S range, it can be said that, when an operation of causing the shift member 1 positioned at the D range to rotate from the D range to the S range side (in a direction opposite to the P range), a reaction force in a direction opposite to the rotation operation direction (a direction toward the P range) occurs against the rotation operation, and a state is obtained in which the wall exists between the D range and the S range. In FIG. 5, the reaction force walls are provided outside the P range, and between the D range and the S range. While it is possible to easily perform a rotation operation for range switching with a little force, in a section from the P range to the D range, a large force is required to perform an operation for rotation from the D range to the S range due to the reaction force.

An example of FIG. 6 will be described as an aspect of the present invention. In FIG. 6, the reaction force walls exist outside the P range and outside the S range before a change (on the left side). Therefore, there is not a reaction force wall between ranges in the whole section from the P range to the S range, and reaction force does not occur against a rotation operation no matter from which range toward which range the rotation operation is performed. Since the D range is shown being dotted, it is known that the vehicle V is currently traveling in the D range.

If an abnormality occurs in the reaction force application instruction means 4, the reaction force wall moves to a position on the opposite side of the P range relative to the current range (a reaction force against a rotation operation in a direction opposite to the parking range (P) relative to the current range is applied). Therefore, in FIG. 6, after the abnormality occurs in the reaction force application instruction means 4 (the right side), the reaction force wall that has existed outside the S range before the occurrence of the abnormality moves to a position between the D range and the S range. Thereby, it becomes difficult to return to the S range (the sports mode range) by a rotation operation, and it is possible to reduce the possibility that the vehicle V travels in the S range with the reaction force application instruction means 4 remaining in the abnormal state.

An example of FIG. 7 will be described as another aspect of the present invention. In FIG. 7, the reaction force walls exist outside the P range, and between the D range and the S range before a change (on the left side). Therefore, there is not a reaction force wall between ranges in the section from the P range to the D range, and a reaction force wall exists between the D range and the S range. Further, since the D range is shown being dotted, it is known that the vehicle V is currently traveling in the D range. In the aspect of FIG. 7, it is assumed that an abnormality has occurred in the reaction force application instruction means 4.

If the driver 10 performs a rotation operation of the shift member 1 and switches the range from the D range to the N range on the parking range (P) side, the reaction force wall moves to a position on the opposite side of the parking range (P) relative to the N range switched to by the rotation operation (a reaction force against the rotation operation in the direction opposite to the parking range (P) relative to the range switched to by the rotation operation). Therefore, in FIG. 7, after the driver 10 switches the range position to the parking range (P) side by the shift member 1 (the right side), the reaction force wall that has existed between the D range and the S range before the range switching moves to a position between the N range and the D range. Thereby, a range of ranges that the driver 10 can switch to by a rotation operation of the shift member 1 is narrowed down, and it is possible to reduce the possibility that the vehicle V travels with the reaction force application instruction means 4 remaining in the abnormal state.

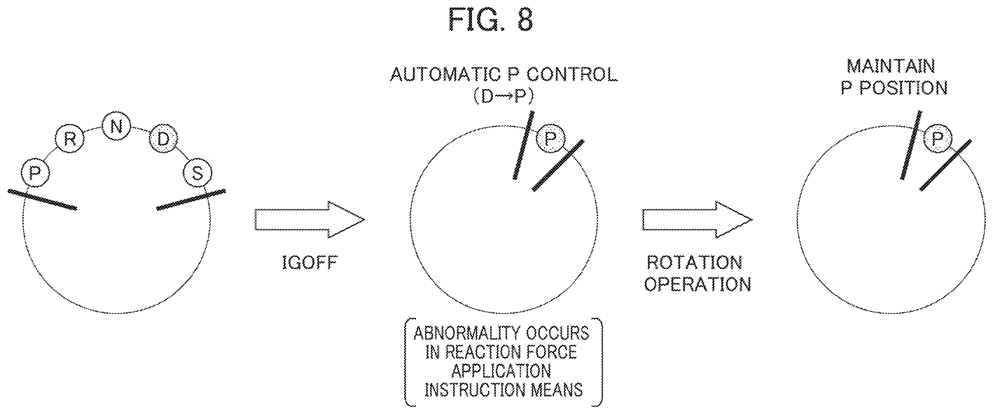

An example of FIG. 8 will be described as another aspect of the present invention. In FIG. 8, the reaction force walls exist outside the P range and outside the S range, and it is known that the vehicle V is currently traveling in the D range as the D range is shown being dotted (the most left side). In this state, the vehicle V stops, and the power source of the vehicle V is turned off by the power switch 8. At this time, in the aspect of the present embodiment, the range of the vehicle V is automatically switched to the parking range (P) by the automatic parking range control means 7 provided in the vehicle V. In this case, the shift member 1 is not physically rotated, but the range is changed from the current position of the shift member 1 set by being rotated (a position for the D range) to the parking range (P).

If an abnormality occurs in the reaction force application instruction means 4, the range of the vehicle V is maintained at the parking range (P) irrespective of a rotation operation of the shift member 1 by the driver 10. Thereby, it is possible to prevent the vehicle V from moving in the state in which the abnormality has occurred in the reaction force application instruction means 4.

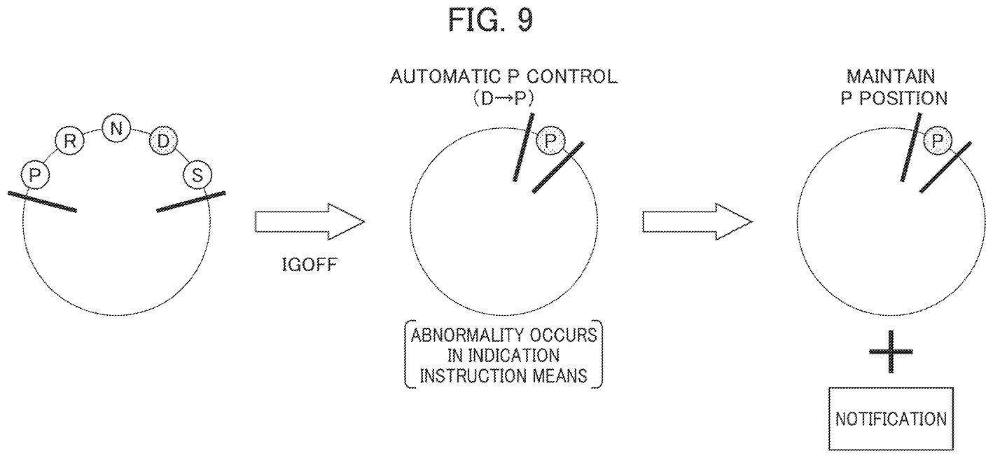

An example of FIG. 9 will be described as another aspect of the present invention. In FIG. 9, the reaction force walls exist outside the P range and outside the S range, and it is known that the vehicle V is currently traveling in the D range as the D range is shown being dotted (the most left side). In this state, the vehicle V stops, and the power source of the vehicle V is turned off by the power switch 8. At this time, in the aspect of the present embodiment, the range of the vehicle V is automatically switched to the parking range (P) by the automatic parking range control means 7 provided in the vehicle V. In this case, the shift member 1 is not physically rotated, but the range is changed from the current position of the shift member 1 set by being rotated (a position for the D range) to the parking range (P).

If an abnormality occurs in the indication instruction means 3 of the shift apparatus S, the range of the vehicle V is maintained at the parking range (P) irrespective of a rotation operation of the shift member 1 by the driver 10. Thereby, it is possible to prevent the vehicle V from moving in the state in which the abnormality has occurred in the reaction force application instruction means 4. Then, in this case, the abnormal state is further notified by the indication portions for all the ranges on the display means 2 of the shift apparatus S blinking. Thereby, it is possible to prevent the vehicle V from moving in the state in which the abnormality has occurred in the reaction force application instruction means 4.

An embodiment for practicing the present invention has been described above using aspects of the invention. However, the present invention is not limited to the embodiment at all, and it goes without saying that the present invention can be practiced in various embodiments within a range not departing from the spirit of the present invention.

### EXPLANATION OF REFERENCE NUMERALS

V: Vehicle
S: Shift apparatus
1: Shift member (operation member)
2: Display means
21: Notification means
3: Indication instruction means
4: Reaction force application instruction means
5: Reaction force application control means
6: Abnormality detection means
7: Automatic parking range control means
8: Power switch
9: Display panel
10: Driver
11: Vehicle travel operation handle

What is claimed is:

1. A shift apparatus of a vehicle, comprising a shift member that is enabled to switch among ranges arranged in order of a parking range, a reverse range, a neutral range and a forward travel range by rotationally operating a dial-type operation member, the shift apparatus further comprising:
reaction force application control means configured to apply a reaction force when the shift member is rotationally operated; and
reaction force application instruction means configured to specify a position to which the reaction force is to be applied, to the reaction force application control means; wherein
in a case where an abnormality occurs in the reaction force application instruction means, the reaction force application control means applies a reaction force against the rotation operation in a direction opposite to the parking range relative to a current range.

2. The shift apparatus of a vehicle according to claim 1, wherein, when a rotation operation from the current range to the parking range side is performed in the case where the abnormality occurs in the reaction force application instruction means, the reaction force application control means applies a reaction force against the rotation operation in the direction opposite to the parking range relative to a range switched to by the rotation operation.

3. The shift apparatus of a vehicle according to claim 1, wherein, in the case where the abnormality occurs in the reaction force application instruction means during automatic parking range control of automatically switching the vehicle to the parking range after a power source of the vehicle is turned off, the vehicle maintains the parking range irrespective of the rotation operation.

4. The shift apparatus of the vehicle according to claim 1, further comprising:
display means configured to, when any of the ranges is switched to, cause the range to be indicated; and
indication instruction means configured to instruct the display means to perform indication; wherein
in a case where an abnormality occurs in the indication instruction means during the automatic parking range control, the abnormality is notified by the display means, and the vehicle maintains the parking range irrespective of the rotation operation.
